(19) United States
(12) Patent Application Publication
(10) Pub. No.: US 2011/0035084 A1
(43) Pub. Date: Feb. 10, 2011

(54) METHOD FOR CALCULATING THE EFFICIENCY OF AN ENERGY STORE, AND USE OF SAID EFFICIENCY

(76) Inventors: Mesut ER, Friedrichshafen (DE); Stefan Wallner, Mattsee (AU); Notker Amann, Friedrichshafen (DE)

Correspondence Address: BRINKS HOFER GILSON & LIONE, P.O. BOX 10395, CHICAGO, IL, 60610, US

(21) Appl. No.: 12/743,784

(22) PCT Filed: Oct. 22, 2008
(86) PCT No.: PCT/EP2008/064237

§ 371 Date: Oct. 29, 2010

(30) Foreign Application Priority Data
Nov. 20, 2007 (DE) 10 2007 047 825.0

(51) Int. Cl. B60L 15/00; B60W 20/00

(52) U.S. Cl. 701/22; 180/65.29

(57) ABSTRACT

Within the scope of the method for calculating the efficiency of the energy store in a parallel hybrid vehicle, said energy store being connected to the electric machine of a parallel hybrid vehicle and comprising an internal combustion engine and at least one electric machine, the efficiency of the energy store is continuously calculated online or in real time in the energy storage module on the basis of an energy store model using known energy-store-specific parameters and energy-store-specific measured variables.

The present invention relates to a method for calculating the efficiency of the energy store in a parallel hybrid vehicle, said energy store being connected to the electric machine of a parallel hybrid vehicle, as claimed in the preamble of patent claim 1. The invention also relates to the use of the calculated efficiency.

The prior art has disclosed hybrid vehicles comprising a hybrid transmission. They comprise at least one electric motor or electric machine in addition to the internal combustion engine. In serial hybrid vehicles, a generator is driven by the internal combustion engine, wherein the generator supplies electric power to the electric motor which drives the wheels. Furthermore, parallel hybrid vehicles are known in which the torques of the internal combustion engine and of at least one electric machine which can be connected to the internal combustion engine are added. In this context, the electric machines can be connected to the belt drive or to the crankshaft of the internal combustion engine. The torques which are generated by the internal combustion engine and/or the at least one electric machine are transmitted to the driven axle via a transmission which is connected downstream.

For example, within the scope of DE102006019679 A1 a drive train is disclosed having an electrically adjustable hybrid transmission and an electrohydraulic control system, a plurality of electric power units and a plurality of torque-transmission mechanisms. In this context, the torque-transmission mechanisms can be selectively engaged by the electrohydraulic control system in order to provide four forward gears, a neutral state, an electric operating mode with a low rotational speed and a high rotational speed, an electrically adjustable operating mode with a low rotational speed and a high rotational speed and a hill stop operating mode.

U.S. Pat. No. 7,174,980 B2 discloses a method for controlling the operating behavior of a hybrid drive of a vehicle, wherein the hybrid drive comprises, as a drive machine, an internal combustion engine and at least one electric machine, and the driveshafts of the drive machines can be operatively connected to a drive train of the vehicle. In this context there is provision that a drag torque characteristic curve of the hybrid drive is set by means of selective actuation of the at least one electric machine.

The prior art discloses that energy stores have power losses which act quadratically in the charging/discharging process. These losses are generally not taken into account.

Furthermore it is known that the efficiency of an energy store is influenced by ambient conditions and the operating state of the energy store, wherein the optimum use of an energy store is not ensured without taking into account the efficiency thereof.

The present invention is based on the object of specifying a method for calculating the efficiency of the energy store in a parallel hybrid vehicle, said energy store being connected to the electric machine of a parallel hybrid vehicle and comprising an internal combustion engine and at least one electric machine, the performance of which method permits the efficiency to be calculated precisely with a low level of expenditure on computing. Furthermore, advantage uses of the efficiency which is calculated according to the invention are to be specified.

This object is achieved for a method by means of the features of patent claim 1. An advantageous use of the calculated efficiency is the subject matter of claim 6. Further embodiments and advantages according to the invention can be found in the subclaims.

Accordingly, a method is proposed in the scope of which the efficiency of the energy store is continuously calculated online or in real time in the energy storage module on the basis of an energy storage model using known energy-store-specific parameters and energy-store-specific measured variables.

According to the invention, in order to calculate the efficiency of the energy store, the current energy-store-specific measured variables of current, voltage and/or temperature are continuously used. According to one variant of the invention, a required current can be used instead of the present current, as a result of which a short-term prediction for a specific power requirement is made possible.

Furthermore, energy store parameters which are determined offline, such as the at least one internal resistance, the double-layer time constant and the charging time constant are used to calculate the efficiency of the energy store. In addition, the voltage dropping across the resistors is summed as a power loss and is placed in relation with the entire voltage which is implemented by the energy store.

If just one internal resistance is assumed, the efficiency Eta of the energy store is obtained as follows:

Eta=active power/energy store power
=(charging power−power loss at the energy store internal resistance)/charging power
=1-abs((present energy store current*energy store internal resistance)/present energy store voltage), wherein abs denotes the absolute value.

In order to take into account the temperature dependence of the internal resistance, the present temperature measured value is preferably used in order to adjust the internal resistance value, which can be done, for example, by means of a characteristic curve which is preferably stored in the energy storage module.

According to one advantageous development of the invention, the calculated efficiency of the energy store at the interface between the energy storage module and the function module of the hybrid drive train (hybrid module) is transmitted to the function module of the hybrid drive train, which ensures that energy-store-specific data are required only in the energy storage module, with the result that the function module of the hybrid drive train is independent of the currently used energy store.

According to the invention it is proposed to use the efficiency of the energy store in the calculation of the overall efficiency in the hybrid drive train. In this context, the module efficiency is calculated in each module of the hybrid drive train (for example electric machine module, energy storage module, transmission module, internal combustion engine module, etc.) and is transmitted to the superordinate function module of the hybrid drive train, wherein in the function module of the hybrid drive train the overall efficiency of the drive train for a required power path is calculated from the chain of efficiency values of the individual modules. In this way, it is possible to calculate in the function module of the hybrid drive train whether, for example, or not it is worth making a load point shift of the internal combustion engine from the energetic point of view.

If, for example, the internal combustion engine is to be adjusted to a better efficiency point within the scope of a load point shift, in which case the excess electric power is to be stored in the energy store, the battery efficiency level is used to calculate, with reference to the resulting overall efficiency, whether this is worth it or not from the energetic point of view after the entire efficiency chain has been run through.

According to the invention it is possible to provide that operating ranges with an unfavorable calculated overall efficiency are marked in the hybrid operating mode as “ranges which are to be avoided” which are to be avoided as far as possible during the operation.

The inventive conception of the continuous calculation permits the efficiency of the energy store to be detected precisely with an acceptable level of computational expenditure. In addition, the independence of the function module or of the function model of the hybrid drive train of a specific energy store is ensured by the calculation of the efficiency in the energy storage module and transmission of the efficiency to the interface with the superordinate function module of the hybrid drive train, with the result that the energy store can be replaced with little expenditure. Furthermore, taking into account the efficiency of the energy store as described in strategic functions gives rise to optimum use of the energy store.

1. A method for calculating the efficiency of the energy store in a parallel hybrid vehicle, said energy store being connected to the electric machine of a parallel hybrid vehicle and comprising an internal combustion engine and at least one electric machine, characterized in that the efficiency of the energy store is continuously calculated online or in real time in the energy storage module on the basis of an energy storage model using known energy-store-specific parameters and energy-store-specific measured variables.

2. The method for calculating the efficiency of the energy store in a parallel hybrid vehicle, said energy store being connected to the electric machine of a parallel hybrid vehicle, as claimed in claim 1, characterized in that, in order to calculate the efficiency of the energy store, the current energy-store-specific measured variables of current, voltage and/or temperature are continuously used, and the at least one internal resistance, the double-layer time constant and/or the charging time constant are used as energy storage parameters, wherein the voltage dropping across the resistors is summed as a power loss and is placed in relation with the entire voltage which is implemented by the energy store.

3. The method for calculating the efficiency of the energy store in a parallel hybrid vehicle, said energy store being connected to the electric machine of a parallel hybrid vehicle, as claimed in claim 1, characterized in that if an internal resistance is present, the efficiency Eta of the energy store is obtained as follows:
Eta=active power/energy store power
=(charging power−power loss at the internal resistance)/charging power
=1-abs((present energy store current*energy store internal resistance)/present energy store voltage).

4. The method for calculating the efficiency of the energy store in a parallel hybrid vehicle, said energy store being connected to the electric machine of a parallel hybrid vehicle, as claimed in claim 2, characterized in that, in order to take into account the temperature dependence of the internal resistance, the present temperature measured value is used in order to adjust the internal resistance value.

5. The method for calculating the efficiency of the energy store in a parallel hybrid vehicle, said energy store being connected to the electric machine of a parallel hybrid vehicle, as claimed in claim 4, characterized in that the adjustment of the internal resistance value takes place as a function of the temperature by means of a characteristic curve.

6. The use of the efficiency, calculated as claimed in claim 1, of the energy store in a parallel hybrid vehicle, said energy store being connected to the electric machine of a parallel hybrid vehicle and comprising an internal combustion engine and at least one electric machine, characterized in that the efficiency of the energy store is used in the calculation of the overall efficiency in the hybrid drive train.

7. The use of the efficiency, calculated as claimed in claim 1, of the energy store which is connected to the electric machine of a parallel hybrid vehicle, as claimed in claim 6, characterized in that the module efficiency is calculated in each module of the hybrid drive train and is transmitted to the function module of the hybrid drive train, wherein in the function module of the hybrid drive train the overall efficiency of the hybrid drive train for a required power path is calculated from the chain of efficiency values of the individual modules, and wherein on the basis of the overall efficiency it is calculated whether or not it is worth making a load point shift of the internal combustion engine from the energetic point of view.

8. The use of the efficiency, calculated as claimed in claim 1, of the energy store which is connected to the electric machine of a parallel hybrid vehicle, as claimed in claim 6, characterized in that on the basis of the calculation of the overall efficiency operating ranges with an unfavorable overall efficiency are marked in the hybrid operating mode as “ranges to be avoided” which are to be avoided as far as possible during the operation.

9. The use of the efficiency, calculated as claimed in claim 1, of the energy store which is connected to the electric machine of a parallel hybrid vehicle, as claimed in claim 6, wherein the calculated efficiency of the energy store at the interface between the energy storage module and the function module of the hybrid drive train is transmitted to the function module of the hybrid drive train, which ensures that energy-store-specific data are required only in the energy storage module, with the result that the function module of the hybrid drive train is independent of the currently used energy store.
